(19) United States
(12) Patent Application Publication
(10) Pub. No.: US 2012/0110476 A1
(43) Pub. Date: May 3, 2012

(54) My online 3D E library

(75) Inventor: Qiuhang Qian, Doraville, GA (US)

(73) Assignee: Qiuhang Richard Qian, Duluth, GA (US)

(21) Appl. No.: 12/927,405

(22) Filed: Nov. 15, 2010

Related U.S. Application Data
(60) Provisional application No. 61/409,529, filed on Nov. 2, 2010.

(51) Int. Cl. G06F 3/048

(52) U.S. Cl. 715/757

(57) ABSTRACT

My online 3D E library is invented. Visitor goes to the library online; check what the materials in each section in a 3D environment. They can borrow, read, listen, watch the materials in the study room or reading room and renew. They also can buy the materials. Business can create and upload the contents by themselves using our pre-designed procedures and tools or get help and support from our technical engineers. The e-commerce web application will be developed by java. Java is an application development language. It contains logic rules, packages, procedures, and triggers. Business and visitor will go through different stages to finish designing and creating contents on the website. The stages will include providing information, creating account, picking service category, picking title category, creating cover page, uploading contents and verifying etc. Business follows the developed procedures and presents their materials in the library on the shelves. Visitor can create contents using the online free tools too.

My online 3D E library is invented for visitors and businesses to visit the library and create the contents by themselves. Visitors log onto the interne and access to the website where on the first page a virtual 3D library displays for 8 seconds before it stops inside the library. On the top right part of the page there are two tabs with a search function. Create Account is for visitors and businesses to create accounts. Login is for visitors and businesses to access to the library and their accounts.

Everyone can access to and explore the 3D library. But only member subscribers with accounts can do activities in the library. These activities include check library sections; brief materials; checkout; renew; return; read; write; post; talk; listen, watch, save; buy; resume, manage account and materials etc. A navigation compass is put in the middle of the library for visitors to explore the library. The visitors and the businesses can use the compass to check different sections in the library. Functional tabs will be built in the library for the businesses and visitors to use. They include study room, recommend, community connector, bulletin board, blog, crate materials, action and account etc

The library will be developed as a 3D library with 21 different services. The layout plan will be graphically designed coping with the 21 services using 3D technology. These services include 1). Reference books, 2). Magazines, 3). Newspapers, 4). New released books, 5). Non-new released books, 6). Fiction movies, 7). Non-fiction movies, 8). Music CDs, 9). Books on tapes, 10). Children's library, 11). Children's games, 12). Classes and lectures, 13), Community connector 14). bulletin board. 15). Recommend, 16). Reading room, 17). Bulletin board, 18) Blog, 19). café, and 20). Help and support. Those service modules will be created orderly in the library and technically developed for visitors to explore. They can be found by the compass navigation tab or through the directory.

Visitors can access to different sections and materials in the library. They can check out the materials and read in the study room or reading room. They can save or resume the readings anytime. When materials are due, they need to return or renew. The materials refer to magazines, newspapers, new and non-new released books, book tapes, DVDs, CDs and reference books etc. Children and youth can do the same things as the adults do in the library. Community connector is designed for businesses to provide business information. Bulletin board is created for providing announcement, notice and other information. Other services have their own functions to serve the library.

### TECHNICAL FIELD

The present invention relates to website and computer server systems that are capable of running and support web application and programs. More particularly, the present invention relates to systems that are capable of running web application and providing the solutions for 3D E library online.

### BRIEF DESCRIPTION OF THE DRAWINGS

FIG. 1 is a logic process flow diagram illustrating how the business flow is designed on the platform.

FIGS. 2 (a) and 2 (b) is a logic process flow diagram illustrating how technically the platform is built for the business to create materials.

### DETAILED DESCRIPTION OF EXEMPLARY EMBODIMENTS

The present invention provides the solutions for online reading, listening, watching materials and other activities in a 3D library environment. The business and the visitor will be required to have an account to do the activities. Once an account is established, all the information related to the account will be saved in the database files. The business follows the steps that are programmed to help them finish creating the materials in the library. The data created will be verified, saved and dispatched. Although the preferred embodiment will be generally described in the context of programs and an operating system running on a server(s), those skilled in the art will recognize that the present invention also can be implemented in conjunction with other program modules for other types of computers. Furthermore, those skilled in the art will recognize that the present invention may be implemented in different network environments.

For example, in a two-tier network, a user communicates directly with a server. This is also known as client-server architecture. A client-server network is an architecture that involves user processes that request service from server processes. The user and server communicate over a network using a given protocol, which must be installed on both the user and the server. In an N-tier architecture, the role of the middle-tier agent can be manifold. It can provide: translation services (as in adapting a legacy application on a mainframe to a user-server environment or acting as a bridge between protocols); scalability services (as in acting as a transaction-processing monitor to balance the load of requests between servers); intelligent agent services (as in mapping a request to a number of different servers, collating the results, and returning a single response to a user).

In a complex network environment, different hardware platforms run different operating systems; multiple protocols are used on these platforms; variable syntax exist between the different but connected applications; run on different geographical locations in which the connected applications reside. It supports a large-scale distributed system. In a distributed computing environment, program modules may be physically located in different local and remote memory storage devices. Execution of the program modules many occur locally in a stand-alone manner or remotely in a user server manner. Examples of such distributed computing environments include local area networks of an office, enterprise-wide computer networks and the global internet.

The detailed description which follows is represented largely in terms of processes and symbolic representations of operations by conventional computer components, including a central processing unit (CPU), memory storage devices for the CPU, display devices, and input devices. Furthermore, these processes and operations may utilize conventional computer components in a heterogeneous distributed computing environment, including remote file servers, remote computer servers, and remote memory storage devices. Each of these conventional distributed computing components is accessible by the CPU via a communication network. The processes and operations performed by the computer include the manipulation of signals by a CPU or remote server and the maintenance of these signals within data structures resident in one or more of the remote memory storage devices.

For the purpose of this discussion, a process is generally conceived to be a sequence of computer-executed steps leading to a desired result. These steps usually require physical manipulation of physical quantities. Usually, though not necessarily, these quantities take the form of electrical, magnetic, or optical signals capable of being stored, transferred, combined, compared, or otherwise manipulated. It is convention for those skilled in the art to refer to representation of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as select, check, pick, brief, checkout, read, listen, watch, renew, buy, return, post and exit etc. that are often associated with manual operations performed by a human operator. The operations described herein can be machine operations performed in conjunction with various input provided by a human operator or a user that interacts with the computer.

In addition, it should be understood that the programs, processes, methods, etc. described herein are not related or limited to any particular computer or apparatus. Rather various types of general purpose machines may be used with the program modules constructed in accordance with the teachings described herein. Similarly, it may prove advantageous to construct a specialized apparatus to perform the method steps described herein by the way of dedicated computer systems in specific network architecture with hardwired logic or programs stored in nonvolatile memory.

Such data structures impose a physical organization upon the collection of data stored within a memory storage device and represent specific electrical or magnetic elements. These symbolic representations are the means used by those skilled in the art of computer programming and computer construction to most effectively convey teachings and discoveries to other skilled in the art. Now refer to the figures.

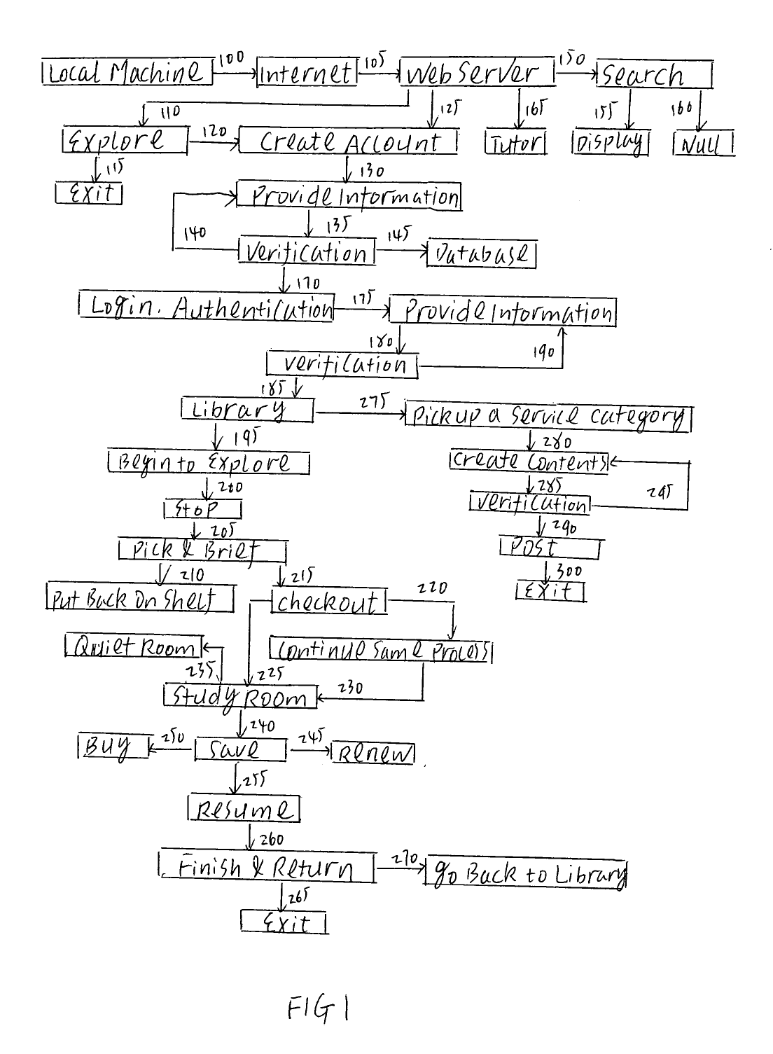

FIG. 1. The visitor logs into a local computer, connects to the interne and accesses to the website (Step 100, 105). The connection is a communication pathway between the user process and the server process. A process created on the client is called the user process. It generates the request from the client on the local machine. A server process is a process passed from the user process and executes on the server. During the server process, it listens, receives, parses and executes the request sent from the user process. The process communicates with the server on behalf of the user process. The server process executes the request. After the process finishes, the returned result is sent back to the user (Visitor). The visitor has several options: create an account, explore, login, or search. If the visitor takes the route of exploring, he or she can use either. the navigation compass or directory (Step 110). Exploring will occur in a 3D library environment consisting of 20 different sections designed and created by Web 3D technology along with other java programs. After exploring, the visitor can exit (Step 115) or choose to create account (Step 120).

If the visitor decides to create account without exploring the library, he or she can do so (Step 125). The visitor provides all the information including the username and password (Step 130). The provided information needs to be verified (Step 135). If the provided data is invalid, the process goes back to the step 130 through the step 140. During the verification, a java function is invoked. It provides a default verification routine to verify the validity of the data. The procedure returns the value TRUE for success and FALSE for failure. If the verification raises an exception, the data becomes invalid, an error is returned. All the information will be saved in the database on the server after verification (Step 145). If the visitor chooses search (Step 150), he or she needs to provide the criteria. if there is a match, the result will be displayed (Step 155), or the process produces no value (Step 160). If the visitor needs to know how to use the system, the demonstration will be shown in the visitor's account (Step 165).

If the visitor chooses to login, authentication is required (Step 170). The visitor provides the information (Step 175). The provided information needs to be verified (Step 180). If the data is valid, the visitor enters the library (Step 185). If the data is not valid, the process goes back to the step 170 until the valid data is provided through the step 190. After entering the library the visitor has two service groups to choose from.

The first group is related to the library materials such as books, music, newspapers that can be checked out and read etc. The second group is related to the other category such as community connector, bulletin board, recommend, reading room, community connector, bulletin board, blog, café, help and support.

If the visitor selects the first group, he or she will use the navigation compass or directory (Step 195). The next steps will be stop at the shelf, pick and brief (Step 200 and 205). If the visitor doesn't like it, he or she can put it back on the shelf (Step 210); if the visitor likes it, he or she checks out the material and continues to walk in the library (Step 215 and 220). The checked out material will be put in the study room to be read (Step 225 and 230). The visitor has the option to read in the reading room with others (Step 235). People can see what each other are reading, their pictures and profiles. The visitor can save and resume reading, renew, or buy the material if he or she likes it. (Step 240,245,250 and 255). Next step is the step that the visitor finishes reading and returning the material (Step 260). The visitor can either exits (Step 265) or goes back to the library again (Step 270).

If the visitor selects the second group, he or she picks a service category and create contents (Step 275 and 280). The contents created need to be verified (Step 285). If the contents are satisfactory, they will be posted (Step 290). If the contents are not satisfactory, the process goes back to the step 280 until the satisfactory data are provided through the step 295. The process ends at leaving the library (Step 300).

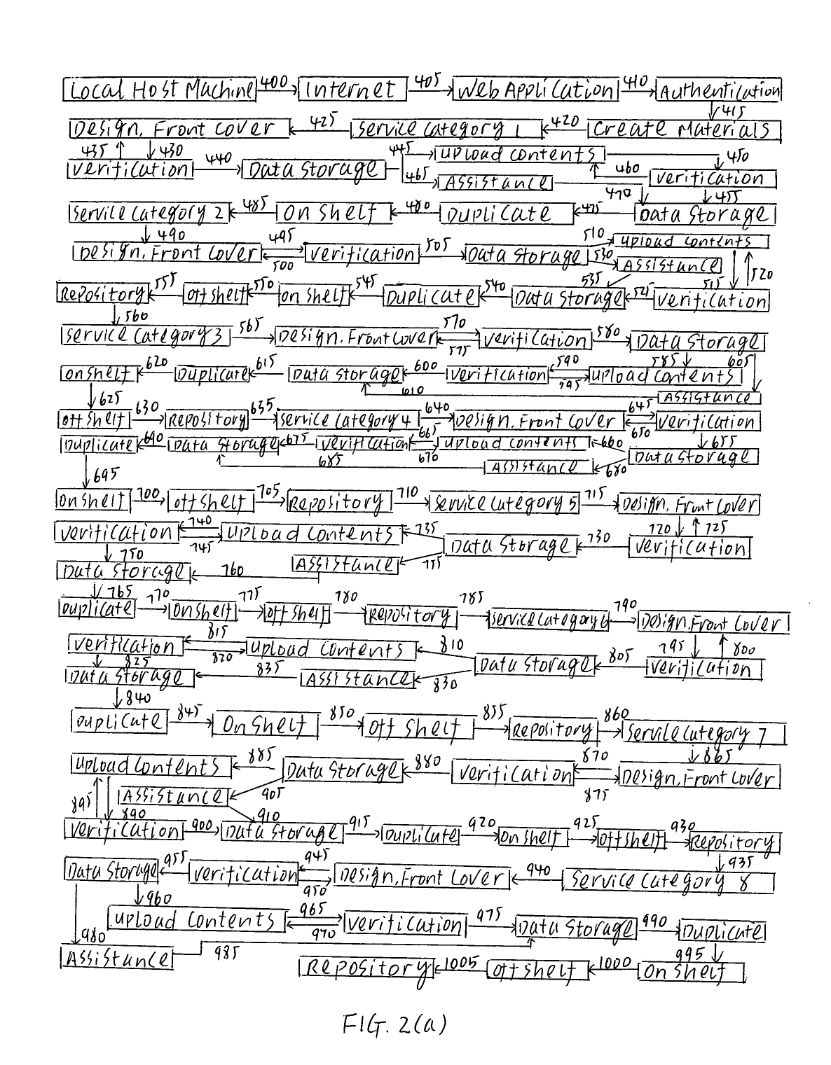

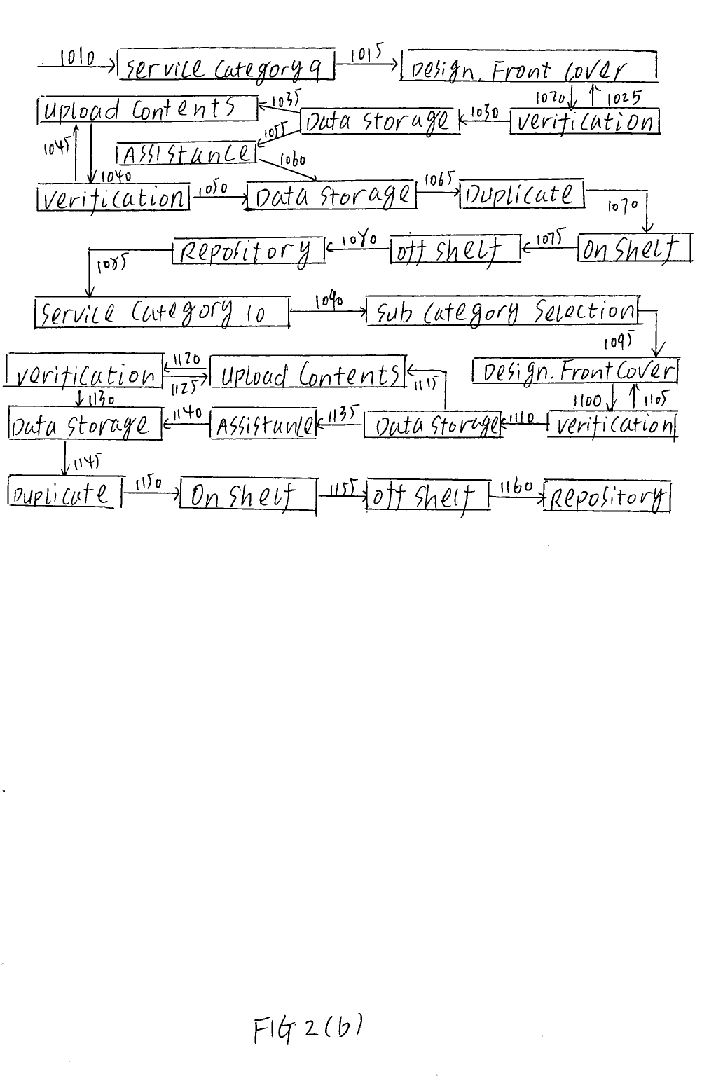

FIG. 2 (a), the business accesses to the internet, the website and logs into the account (Step 400, 405 and 410). The business selects the create materials button and chooses the service category item 1 (Step 415 and 420). There are 10 different service categories under the create materials button. Each service category has similar materials creation process which includes front page creation, verification, category determination, uploading materials, verification, storing data, putting on shelf etc. The process is developed by java. Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. The tools include customized templates, background colors, patterns, canvas and editor etc.

Service category item 1 is about reference books. The business picks a front cover template and creates the front cover by using the online free tools; or the business chooses to upload its own front cover (Step 425). The finished front cover needs to be verified (Step 430). If the front cover is not satisfactory, the process goes back to the previous step 425 through the step 435. After the verification, the front cover will be saved on the server according to the title (Step 440). The next step is creating the materials through uploading or assistance (Step 445 or 465). If the business chooses to upload the materials, the uploaded materials need to be verified (Step 450). During uploading, there are three stages involved A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the results.

If the uploaded materials are satisfactory, they will be saved in the database on the server (Step 455). If the uploaded materials are not satisfactory, the process goes back to the step 445 through the step 460 until the data are good and valid. The business can choose to get assistance (Step 465). If so, the assistance process takes over. The assistance process will include acquiring, verifying, locating and uploading the materials to the designated data storage on the server (Step 470). The materials will be duplicated as readable format and put on the shelf with link (Step 475 and 480). The library sections and shelves including reference books are designed with web 3D technology in an animation simulation environment. The development will include geometry representation, 3D transformations, color, shading, lighting, digital images, rasterization and fragment processing, multiple rendering passes, anti-aliasing, composing, blending transparency, image processing techniques, basic transform techniques, texture mapping techniques, lighting techniques, CAD and modeling techniques, scene realism, natural detail, illustration and artistic techniques, scientific visualization, 3D vectors, projection matrices, viewing transforms, modeling transforms, parallel and perpendicular vectors, reflection vector, lighting equations, and function approximations. The reference books will be updated by taking the same process under the account button in the business' account.

The business takes the step 485 to select service category item 2. Service category item 2 is related to magazines. The business picks a front cover template and creates the front cover by using the online free tools; or the business chooses to upload its own front cover (Step 490). The finished front cover needs to be verified (Step 495). If the front cover is not satisfactory, the process goes back to the previous step 490 through the step 500. After the verification, the front cover will be saved on the server according to the title (Step 505). The next step is creating the materials through uploading or assistance (Step 510 or 530). If the business chooses to upload the materials, the uploaded materials need to be verified (Step 515). During uploading, there are three stages involved A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the results.

If the uploaded materials are satisfactory, they will be saved in the database on the server (Step 525). If the uploaded materials are not satisfactory, the process goes back to the step 510 through the step 520 until the data are good and valid. The business can choose to get assistance (Step 530). If so, the assistance process takes over. The assistance process will include acquiring, verifying, locating and uploading the materials to the designated data storage on the server (Step 535). The materials will be duplicated as readable format and put on the shelf with link (Step 540 and 545). The library sections and shelves including magazines are designed with web 3D technology in an animation simulation environment. The development will include geometry representation, 3D transformations, color, shading, lighting, digital images, rasterization and fragment processing, multiple rendering passes, anti-aliasing, composing, blending transparency, image processing techniques, basic transform techniques, texture mapping techniques, lighting techniques, CAD and modeling techniques, scene realism, natural detail, illustration and artistic techniques, scientific visualization, 3D vectors, projection matrices, viewing transforms, modeling transforms, parallel and perpendicular vectors, reflection vector, lighting equations, and function approximations. The magazines will be taken off shelves when new releases come in (Step 550). The business can do it under the account in the business' account. The old magazines will be put on the repository magazine shelves (Step 555).

The business takes the step 560 to select service category item 3. Service category item 3 is related to newspapers. The business picks a front cover template and creates the front cover by using the online free tools; or the business chooses to upload its own front cover (Step 565). The finished front cover needs to be verified (Step 570). If the front cover is not satisfactory, the process goes back to the previous step 565 through the step 575. After the verification, the front cover will be saved on the server according to the title (Step 580). The next step is creating the materials through uploading or assistance (Step 585 or 605). If the business chooses to upload the materials, the uploaded materials need to be verified (Step 590). During uploading, there are three stages involved A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the results.

If the uploaded materials are satisfactory, they will be saved in the database on the server (Step 600). If the uploaded materials are not satisfactory, the process goes back to the step 510 through the step 585 until the data are good and valid. The business can choose to get assistance (Step 605). If so, the assistance process takes over. The assistance process will include acquiring, verifying, locating and uploading the materials to the designated data storage on the server (Step 610). The materials will be duplicated as readable format and put on the shelf with link (Step 615 and 620). The newspaper section will be designed with web 3D technology in an animation simulation environment. The development will include geometry representation, 3D transformations, color, shading, lighting, digital images, rasterization and fragment processing, multiple rendering passes, anti-aliasing, composing, blending transparency, image processing techniques, basic transform techniques, texture mapping techniques, lighting techniques, CAD and modeling techniques, scene realism, natural detail, illustration and artistic techniques, scientific visualization, 3D vectors, projection matrices, viewing transforms, modeling transforms, parallel and perpendicular vectors, reflection vector, lighting equations, and function approximations. The newspapers will be taken off the shelf when next day newspaper comes in (Step 625). The business can do it under the account in the business' account. The old newspaper will be put on the repository newspaper shelf (Step 630).

Step 635 is the step that the business chooses service category item 4. Service category item 4 is related to new release books. The business picks a front cover template and creates the front cover by using the online free tools; or the business chooses to upload its own front cover (Step 640). The finished front cover needs to be verified (Step 645). If the front cover is not satisfactory, the process goes back to the previous step 640 through the step 650. After the verification, the front cover will be saved on the server according to the title (Step 655). The next step is creating the materials through uploading or assistance (Step 660 or 680). If the business chooses to upload the materials, the uploaded materials need to be verified (Step 665). One or more fetches may be required to transfer the results.

If the uploaded materials are satisfactory, they will be saved in the database on the server (Step 675). If the uploaded materials are not satisfactory, the process goes back to the step 660 through the step 670 until the data are good and valid. The business can choose to get assistance (Step 680). If so, the assistance process takes over. The assistance process will include acquiring, verifying, locating and uploading the materials to designated data storage on the server (Step 685). The materials will be duplicated as readable format and put on the shelf with link (Step 690 and 695). The new release books section will be designed with web 3D technology in an animation simulation environment. The new release books will be taken off the shelves after a period of time (Step 700). The business can do it under the account in the business' account. The taken off books will be put on the repository book shelves (Step 705).

Step 710 is the step that the business chooses service category item 5. Service category item 5 is related to books other than new releases. The business picks a front cover template and creates the front cover by using the online free tools; or the business chooses to upload its own front cover (Step 715). The finished front cover needs to be verified (Step 720). If the front cover is not satisfactory, the process goes back to the previous step 715 through the step 725. After the verification, the front cover will be saved on the server according to the title (Step 730). The next step is creating the materials through uploading or assistance (Step 735 or 755). If the business chooses to upload the materials, the uploaded materials need to be verified (Step 740). One or more fetches may be required to transfer the results.

If the uploaded materials are satisfactory, they will be saved in the database on the server (Step 750). If the uploaded materials are not satisfactory, the process goes back to the step 735 through the step 745 until the data are good and valid. The business can choose to get assistance (Step 755). If so, the assistance process takes over. The assistance process will include acquiring, verifying, locating and uploading the materials to designated data storage on the server (Step 760). The materials will be duplicated as readable format and put on the shelf with link (Step 765 and 770). The old books section will be designed with web 3D technology in an animation simulation environment. The books will be taken off the shelves after a period of time (Step 775). The business can do it under the account in the business' account. The taken off books will be put on the repository book shelves (Step 780).

Step 785 is the step that the business chooses service category item 6. Service category item 6 is related to movies. The business picks a front cover template and creates the front cover by using the online free tools; or the business chooses to upload its own front cover (Step 790). The finished front cover needs to be verified (Step 795). If the front cover is not satisfactory, the process goes back to the previous step 790 through the step 800. After the verification, the front cover will be saved on the server according to the title (Step 805). The next step is creating the materials through uploading or assistance (Step 810 or 830). If the business chooses to upload the materials, the uploaded materials need to be verified (Step 815). One or more fetches may be required to transfer the results.

If the uploaded materials are satisfactory, they will be saved in the database on the server (Step 825). If the uploaded materials are not satisfactory, the process goes back to the step 810 through the step 820 until the data are good and valid. The business can choose to get assistance (Step 830). If so, the assistance process takes over. The assistance process will include acquiring, verifying, locating and uploading the materials to designated data storage on the server (Step 835). The materials will be duplicated as readable format and put on the shelf with link (Step 840 and 845). The movie section will be designed with web 3D technology in an animation simulation environment. The old movies will be taken off the shelf after a period of time (Step 850) and put on the repository movie shelf (Step 855).

Step 860 is the step that the business chooses service category item 7. Service category item 7 is related to non-fiction DVDs other than movies. The business picks a front cover template and creates the front cover by using the online free tools; or the business chooses to upload its own front cover (Step 865). The finished front cover needs to be verified (Step 870). If the front cover is not satisfactory, the process goes back to the previous step 865 through the step 875. After the verification, the front cover will be saved on the server according to the title (Step 880). The next step is creating the materials through uploading or assistance (Step 885 or 905). If the business chooses to upload the materials, the uploaded materials need to be verified (Step 890). One or more fetches may be required to transfer the results.

If the uploaded materials are satisfactory, they will be saved in the database on the server (Step 900). If the uploaded materials are not satisfactory, the process goes back to the step 885 through the step 895 until the data are good and valid. The business can choose to get assistance (Step 905). If so, the assistance process takes over. The assistance process will include acquiring, verifying, locating and uploading the materials to designated data storage on the server (Step 910). The materials will be duplicated as readable format and put on the shelf with link (Step 915 and 920). The non-fiction movie section will be designed with web 3D technology in an animation simulation environment. The non-fiction movies will be taken off the shelf after a period of time (Step 925) and put in the repository area (Step 930).

Step 935 is the step that the business chooses service category item 8. Service category item 8 is related to music items. The business picks a front cover template and creates the front cover by using the online free tools; or the business chooses to upload its own front cover (Step 940). The finished front cover needs to be verified (Step 945). If the front cover is not satisfactory, the process goes back to the previous step 940 through the step 950. After the verification, the front cover will be saved on the server according to the title (Step 955). The next step is creating the materials through uploading or assistance (Step 960 or 980). If the business chooses to upload the materials, the uploaded materials need to be verified (Step 965). One or more fetches may be required to transfer the results.

If the uploaded materials are satisfactory, they will be saved in the database on the server (Step 975). If the uploaded materials are not satisfactory, the process goes back to the step 960 through the step 970 until the data are good and valid. The business can choose to get assistance (Step 980). If so, the assistance process takes over. The assistance process will include acquiring, verifying, locating and uploading the materials to designated data storage on the server (Step 985). The materials will be duplicated as readable format and put on the shelf with link (Step 990 and 995). The music items section will be designed with web 3D technology in an animation simulation environment. The music items will be taken off the shelf after a period of time (Step 1000) and put in the repository area (Step 1005).

Refer to FIG. 2(b). Step 1010 is the step that the business selects the service item 9 under create materials. Service category item 9 is related to audio books. The business picks a front cover template and creates the front cover by using the online free tools; or the business chooses to upload its own front cover (Step 1015). The finished front cover needs to be verified (Step 1020). If the front cover is not satisfactory, the process goes back to the previous step 1015 through the step 1025. After the verification, the front cover will be saved on the server according to the title (Step 1030). The next step is creating the materials through uploading or assistance (Step 1035 or 1055). If the business chooses to upload the materials, the uploaded materials need to be verified (Step 1040). One or more fetches may be required to transfer the results.

If the uploaded materials are satisfactory, they will be saved in the database on the server (Step 1050). If the uploaded materials are not satisfactory, the process goes back to the step 1035 through the step 1045 until the data are good and valid. The business can choose to get assistance (Step 1055). If so, the assistance process takes over. The assistance process will include acquiring, verifying, locating and uploading the materials to designated data storage on the server (Step 1060). The materials will be duplicated as readable format and put on the shelf with link (Step 1065 and 1070). The music items section will be designed with web 3D technology in an animation simulation environment. The audio books will be taken off the shelf after a period of time (Step 1075) and put in the auto book repository shelf (Step 1080).

Step 1085 is the step after the business selects the service category item 10. Service category item 10 represents the children's library. The business selects a sub-category in the library (Step 1090) and picks a front cover template and creates the front cover by using the online free tools; or the business chooses to upload its own front cover (Step 1095). The finished front cover needs to be verified (Step 1100). If the front cover is not satisfactory, the process goes back to the previous step 1095 through the step 1105. After the verification, the front cover will be saved on the server according to the title (Step 1110). The next step is creating the materials through uploading or assistance (Step 1115 or 1135). If the business chooses to upload the materials, the uploaded materials need to be verified (Step 1120). One or more fetches may be required to transfer the results.

If the uploaded materials are satisfactory, they will be saved in the database on the server (Step 1130). If the uploaded materials are not satisfactory, the process goes back to the step 1115 through the step 1125 until the data are good and valid. The business can choose to get assistance (Step 1135). If so, the assistance process takes over. The assistance process will include acquiring, verifying, locating and uploading the materials to designated data storage on the server (Step 1140). The materials will be duplicated as readable format and put on the shelf with link (Step 1145 and 1150). The children's library section will be designed with web 3D technology in an animation simulation environment. The children library's items will be taken off the shelf after a period of time (Step 1155) and put in the repository area (Step 1160).

1. My Online 3D E Library
